(19) United States
(12) Patent Application Publication
(10) Pub. No.: US 2024/0128575 A1
(43) Pub. Date: Apr. 18, 2024

(54) MULTIMODAL ATTACHMENT MECHANISM

(71) Applicant: Hand Held Products, Inc., Charlotte, NC (US)

(72) Inventors: Hardik Yomesh JANI, Charlotte, NC (US); Hong Kun CHENG, Charlotte, NC (US); Kevin SABER, Charlotte, NC (US)

(21) Appl. No.: 18/478,480

(22) Filed: Sep. 29, 2023

(30) Foreign Application Priority Data
Oct. 14, 2022 (CN) 202211258921.9

(51) Int. Cl. H01M 50/262; F16B 2/04; H01M 50/247

(52) U.S. Cl. CPC H01M 50/262; F16B 2/04; H01M 50/247; G06F 1/163; H01M 2220/30

(57) ABSTRACT

Various devices, assemblies, components, systems, and methods are provided relating to multimodal attachment. An example device may include two actuatable hooks including a first actuatable hook and a second actuatable hook. The first actuatable hook may be configured to move between a first engaged position and first disengaged position. The second actuatable hook may be configured to move between a second engaged position and second disengaged position. The first actuatable hook may be actuatable in a different direction than the second actuatable hook. The two actuatable hooks may each be configured to engage with one or more corresponding receiving catches on a receiving device in the first engaged position and the second engaged position, respectively.

### CROSS-REFERENCE TO RELATED APPLICATIONS

This application claims priority pursuant to 35 U.S.C. 119(a) to Chinese Application No. 202211258921.9, filed Oct. 14, 2022, which application is incorporated herein by reference in its entirety.

### TECHNICAL FIELD

The present disclosure relates to multimodal attachment mechanisms capable of engaging and disengaging in multiple manners to allow versatile, ergonomic operation. Various devices and methods are also provided. In some example embodiments, the attachment mechanisms disclosed herein may be used to attach a battery and a battery-powered electronic device.

### BACKGROUND

Attachment mechanisms may be designed with a particular intended use case or a particular intended manner of operation. While this intended use case or particular intended manner of operation may work sufficiently for some or even a majority of users, other users may find the intended operation cumbersome and difficult. For example, removal of a battery from a battery-powered electronic device may require operating a particular disconnection mechanism, which mechanism may be placed in a location that is difficult for some users to reach (e.g., left handed users) or is otherwise cumbersome or difficult to operate. In addition, attachment mechanisms may require additional steps, such as removing a battery-powered electronic device from its mounting location prior to being able to disconnect the battery. Through applied effort, ingenuity, and innovation, Applicant has solved problems relating to attachment mechanisms by developing solutions embodied in the present disclosure, which are described in detail below.

### BRIEF SUMMARY

Various embodiments of the present disclosure include batteries, assemblies, mobile devices, and corresponding systems, devices, components, and methods related to multimodal attachment mechanisms.

Various embodiments of the present disclosure may include a device. The device may include two actuatable hooks comprising a first actuatable hook and a second actuatable hook. The first actuatable hook may be configured to move between a first engaged position and first disengaged position. The second actuatable hook may be configured to move between a second engaged position and second disengaged position. The first actuatable hook may be actuatable in a different direction than the second actuatable hook. The two actuatable hooks each may be configured to engage with one or more corresponding receiving catches on a receiving device in the first engaged position and the second engaged position, respectively.

In some embodiments, the two actuatable hooks are rotatable about respective pin axes. The respective pin axes may be parallel to each other. In some embodiments, each of the two actuatable hooks may include an actuator configured to be depressed by a user, wherein the actuatable hooks each may be configured to rotate about a respective pin axis in response to actuation of the respective actuators. In some embodiments, the device is a battery, and the receiving device is a battery-powered electronic device. In some embodiments, at least one of the two actuatable hooks may include a spring configured to urge the at least one of the two actuatable hooks towards the respective engaged positions. In some embodiments, the two actuatable hooks may be oriented such that the two actuatable hooks are configured to move in inverse directions between the respective engaged positions and the respective disengaged positions. In some embodiments, the two actuatable hooks may be disposed on opposite sides of an engagement portion of the device.

Various embodiments of the present disclosure may include an assembly. The assembly may include a first device and a second device. The first device may include two actuatable hooks including a first actuatable hook and a second actuatable hook. The first actuatable hook may be configured to move between a first engaged position and first disengaged position. The second actuatable hook may be configured to move between a second engaged position and second disengaged position. The first actuatable hook may be actuatable in a different direction than the second actuatable hook. The second device may include two receiving catches including a first receiving catch configured to engage the first actuatable hook and a second receiving catch configured to engage the second actuatable hook.

In some embodiments, the first device may be configured to engage the second device by engaging the first actuatable hook with the first receiving catch and engaging the second actuatable hook with the second receiving catch. The first device may be configured to translate into engagement with the second device. During the translation, both the first actuatable hook and the second actuatable hook may be configured to deflect from the respective engaged positions temporarily towards the respective disengaged positions before the first actuatable hook may engage the first receiving catch and the second actuatable hook may engage the second receiving catch. The first device may be configured to rotate into a first engagement with the second device without rotating the second actuatable hook from the second engaged position. During the rotation of the first engagement, the first actuatable hook may be configured to deflect from the first engaged position temporarily towards the first disengaged position before the first actuatable hook engages the first receiving catch. The first device may be configured to rotate into a second engagement with the second device without rotating the first actuatable hook from the first engaged position. During the rotation of the second engagement, the second actuatable hook may be configured to deflect from the second engaged position temporarily towards the second disengaged position before the second actuatable hook engages the second receiving catch. In some embodiments, the first device may be a battery, and the second device may be a battery-powered electronic device configured to engage the battery to receive power. The battery-powered electronic device may be configured to attach to a user's appendage, and the battery may be configured to engage and disengage from the battery-powered electronic device while the battery-powered electronic device is attached to the user's appendage. In some embodiments, each of the two actuatable hooks may include an actuator configured to be depressed by a user. The actuatable hooks may each be configured to rotate about a respective pin axis in response to actuation of the respective actuators. The respective pin axes may be parallel to each other, and the two actuatable hooks may be configured to rotate in inverse directions between the respective engaged positions and the respective disengaged positions. In some embodiments, the assembly may include springs associated with the two actuatable hooks. The springs may be configured to urge the two actuatable hooks towards the respective engaged positions. In some embodiments, the two actuatable hooks may be disposed on opposite sides of an engagement portion of the first device, and the two receiving catches may be disposed on opposite sides of an engagement portion of the second device.

Various embodiments may include a method of decoupling two devices. The two devices may include a first device and a second device. The first device may include two actuatable hooks including a first actuatable hook and a second actuatable hook. The first actuatable hook may be configured to move between a first engaged position and first disengaged position. The second actuatable hook may be configured to move between a second engaged position and second disengaged position. The first actuatable hook may be actuatable in a different direction than the second actuatable hook. The second device may include two receiving catches including a first receiving catch configured to engage the first actuatable hook and a second receiving catch configured to engage the second actuatable hook. The method may include depressing at least one of the two actuatable hooks and decoupling the two devices.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

The following drawings are illustrations of a particular embodiment of the present disclosure and therefore do no limit the scope of the present disclosure. The drawings are not necessarily drawn to scale and are intended for use in conjunction with the explanation in the following detailed description.

FIG. 1 illustrates a cross-sectional view of a battery having two actuatable hooks in accordance with various embodiments of the present disclosure.

FIGS. 2A to 2B illustrate an example battery engaging an example battery-powered electronic device in accordance with various embodiments of the present disclosure.

FIGS. 3A to 3B illustrate an example battery engaging an example battery-powered electronic device in accordance with various embodiments of the present disclosure.

FIG. 4 illustrates a cross-sectional view of an example battery engaged with an example battery-powered electronic device in accordance with various embodiments of the present disclosure.

FIG. 5 illustrates a cross-sectional view of an example battery and an example battery-powered electronic device with rotated actuatable hooks in accordance with various embodiments of the present disclosure.

FIG. 6 illustrates a side view of an example battery and an example battery-powered electronic device in accordance with various embodiments of the present disclosure.

FIG. 7 illustrates a perspective view of an example battery and an example battery-powered electronic device in accordance with various embodiments of the present disclosure.

FIG. 8 illustrates a perspective view of an example battery engaged with an example battery-powered electronic device in accordance with various embodiments of the present disclosure.

FIG. 9 illustrates an example battery-powered electronic device in accordance with various embodiments of the present disclosure.

FIG. 10A illustrates an example battery-powered electronic device and battery attached to a user's left arm in accordance with various embodiments of the present disclosure.

FIG. 10B illustrates an example battery-powered electronic device and battery attached to a user's right arm in accordance with various embodiments of the present disclosure.

FIGS. 11A-11B are example flow diagrams illustrating example methods of single-hook removal in accordance with various embodiments of the present disclosure.

FIGS. 12A-12B are example flow diagrams illustrating example methods of plurality hooks removal in accordance with various embodiments of the present disclosure.

### DETAILED DESCRIPTION

Some embodiments of the present invention will be described in a more detailed manner hereinafter with reference to the accompanying drawings, in which some, embodiments of the invention are shown. Reference numbers refer to like elements throughout the drawings. Multiple embodiments of the current invention may be embodied in different forms and should not be limited to the embodiments set forth herein. Rather, these embodiments are provided so that this disclosure will satisfy applicable legal requirements.

As used herein, terms such as “front,” “rear,” “top,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on, but not necessarily requiring directly on an edge or other referenced location. The terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present invention. As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

As used herein, the term “battery-powered” is intended to refer to devices capable of engaging a battery to receive electrical power in at least some circumstances. The term “battery-powered” is intended to be interpreted inclusively and includes devices capable of engaging a battery as well as devices capable of being plugged in to a non-battery power source in at least some circumstances.

The figures are provided to illustrate some examples of the invention described. The figures are not to limit the scope of the present embodiment of the invention or the appended claims. Aspects of the example embodiment are described below with reference to example applications for illustration. It should be understood that specific details, relationships, and methods are set forth to provide a full understanding of the example embodiment. One of ordinary skill in the art recognize the example embodiment can be practice without one or more specific details and/or with other methods.

The present disclosure relates to multimodal attachment mechanisms capable of engaging and disengaging in multiple manners to allow versatile, ergonomic operation. Various devices and methods are also provided. In some example embodiments, the attachment mechanisms disclosed herein may be used to attach a battery and a battery-powered electronic device. Various attachment mechanisms typically have a single mode of engagement/disengagement, requiring the user to adapt to the use conditions of the particular mechanism and failing to accommodate all users. For example, the removal of a battery can be tedious and inefficient for users who must be able to execute a specific release motion, such as a right-handed release button for left-handed users or a two-hand release for someone with only one available hand.

In some instances, a battery-powered electronic device may be worn by a user or mounted to another operational location (e.g., within a vehicle), and a removable battery may require removal of the battery-powered electronic device from its mounting location prior to disconnecting the battery. Even in an instance in which the battery-powered electronic device remains mounted during battery changes, the battery may not be accessible or operable from multiple directions or in multiple modes of engagement or disengagement. For example, the battery may require two steps of actuators to remove a single battery. These two steps for removal may favor one hand dominance over another (e.g., right hand over left hand) or may require both hands when only one is available. The user may be opposite hand dominant (e.g., left-handed), and a two-step removal or right-handed removal may be difficult and cumbersome. In some embodiments, a user may prefer one or more different modes of engagement or may inadvertently misalign the battery when attempting to attach it to the battery-powered electronic device.

Embodiments of the present disclosure provide multiple modes of engagement and/or disengagement of a first device and a second device, which may facilitate multiple manners of operation of the attachment mechanisms to allow versatile, ergonomic operation. Various embodiments of the present disclosure may additionally or alternatively allow a greater range of acceptable engagement orientations without failure, thus tolerating substantial misalignment and improving operation of the respective devices. While some embodiments discussed herein include batteries and battery-powered electronic devices, these examples should be understood to not limit the overall scope of the disclosure, and the attachment mechanisms disclosed herein may be used for connecting any two devices that could be engageable and disengageable from each other by a user.

Embodiments of the present disclosure may operate to allow ambidextrous, multimodal removal of a first device from a second device, in some instances, without removing the second device from one or more appendages or other mounting locations. The first device and the second device may be engaged via an attachment mechanism that rigidly secures the devices to each other. In some embodiments, the attachment mechanism may include two or more actuatable hooks associated with the first device, with the two or more actuatable hooks being configured to engage two or more corresponding receiving catches on a second device. Each of the two or more actuatable hooks may be movable between an engaged position and a disengaged position. In some embodiments, the actuatable hooks are capable of rigidly holding the devices together in an instance in which both hooks are in their respective engaged positions (e.g., a first and a second engaged position) and the hooks are engaged with the respective receiving catches.

The hooks may rotate and/or translate in different directions from each other. These different directions may operate to allow the hooks to secure the first device to the second device without additional retaining mechanisms (e.g., various protrusions and alignment features may still be used, but some embodiments may not require any additional attachment mechanisms, whether fixed or movable, to prevent the first device from decoupling from the second device). For example, in some embodiments, the two actuatable hooks are disposed on opposite sides of an engagement portion of the device. In some embodiments, the two actuatable hooks are linearly opposite each other on at least one device. The actuatable hooks may thereby engage the second device, whether the battery, the battery-powered electronic device, or another device, from the different directions. In some embodiments, the receiving catches may likewise be oriented in different directions (e.g., facing each other in the depicted embodiments) to allow the actuatable hooks to engage therewith.

In some embodiments, the first device may be engageable with the second device by translating and/or rotating the first device relative to the second device. In various embodiments, the first device may be in an engaged position when each of the hooks is engaged with each of the receiving catches. The various hooks may become engaged with the respective receiving catches in a plurality of different manners. For example, in some embodiments, the first device may translate into engagement with the second device while two actuatable hooks simultaneously or substantially simultaneously engage two respective receiving catches, deflecting the actuatable hooks temporarily out of the engaged position to allow the hooks to snap into the receiving catches. In some embodiments, one of the actuatable hooks may be engaged with its respective receiving catch before another of the actuatable hooks, such as in an embodiment in which the first device rotates into engagement with the second device. In some such embodiments, the actuatable hook that engages the receiving catch first may not need to deflect and only the latter actuatable hook may deflect out of the engaged position as it engages the respective receiving catch. In some embodiments, various combinations of translation and rotation may occur during engagement of the first device and the second device, so long as the actuatable hooks ultimately engage their corresponding receiving catches. In some embodiments, the hooks may be spring-loaded to urge each of the hooks towards the respective engaged positions.

The first device and the second device may be disengaged via the reverse of the aforementioned steps. In some embodiments, a user may depress one or more of the actuatable hooks to disengage the depressed hook(s) from the respective receiving catch(es) and allow the first device to translate and/or rotate out of engagement with the second device.

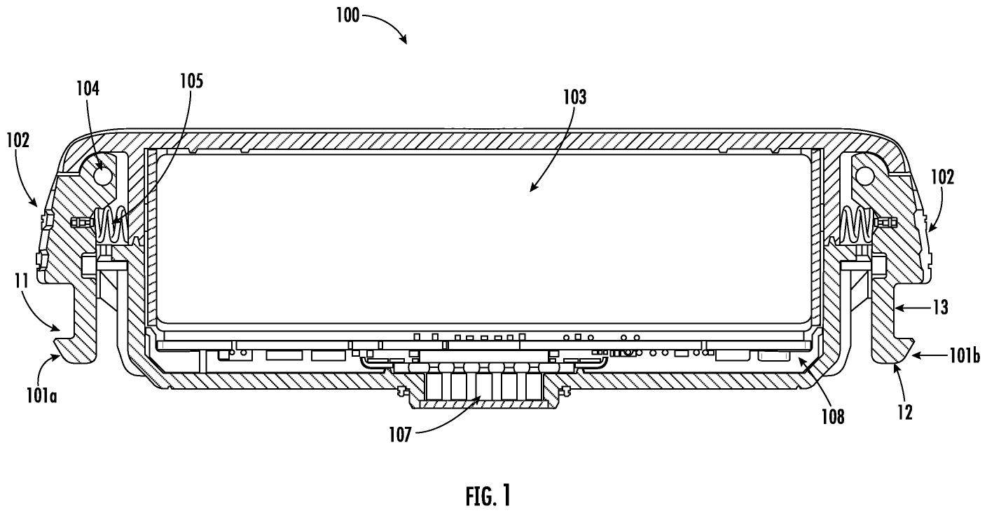

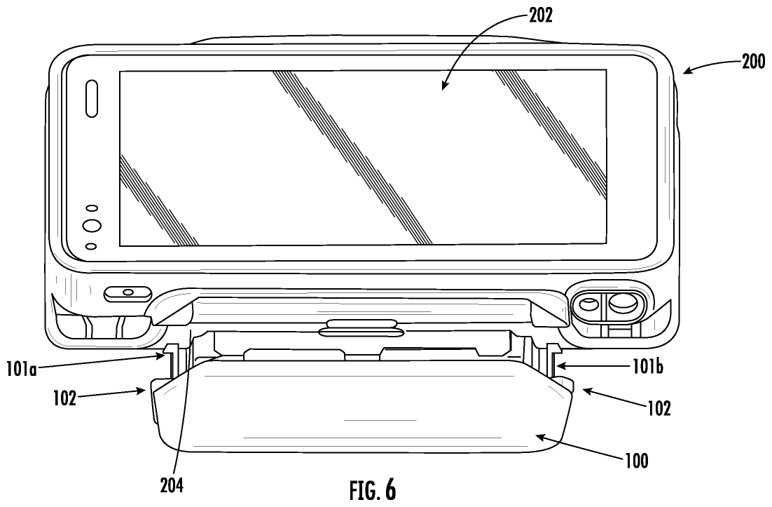

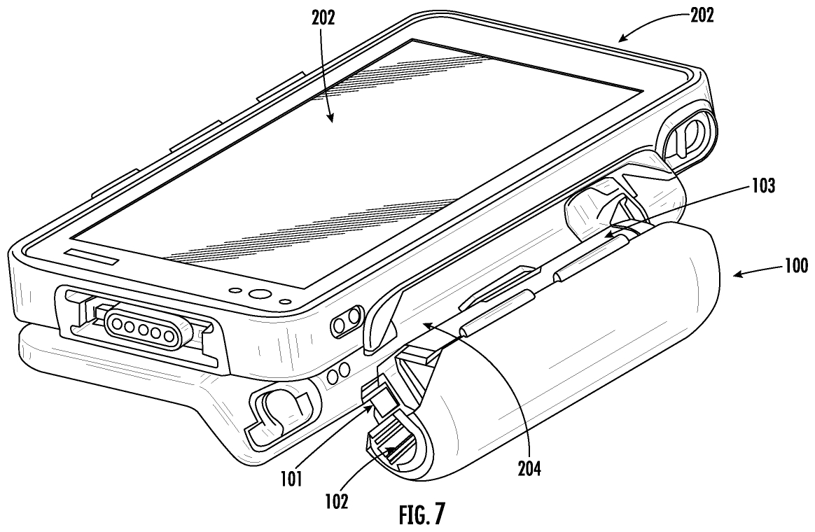

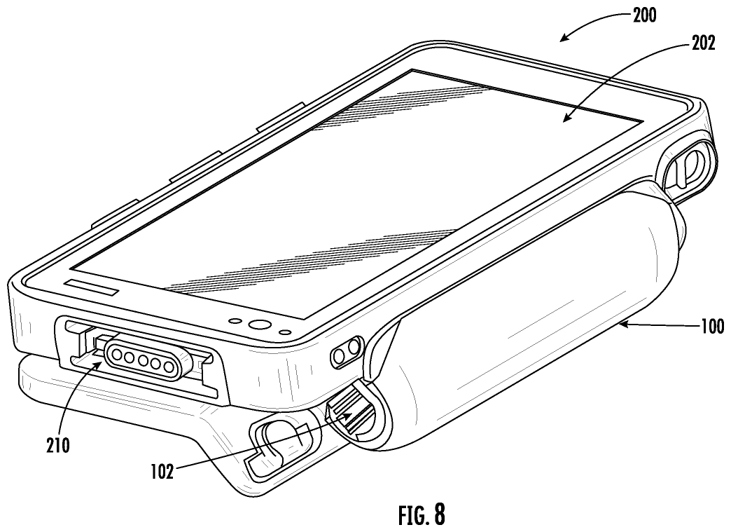

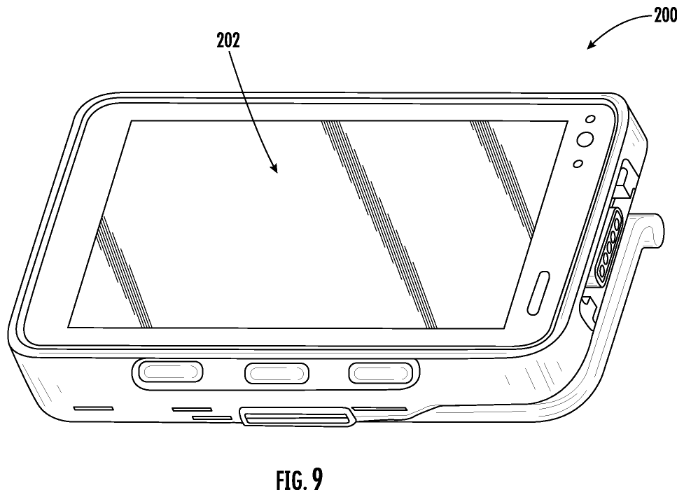

In some embodiments, the first device may be either a battery or a battery-powered electronic device, and the second device may be the other of the battery or the battery-powered electronic device. In some embodiments, the first device may include a battery and the second device may include a battery-powered electronic device (e.g., a wearable electronic device). Non-limiting embodiments of the battery are described with reference to FIGS. 1-12B. The embodiment may be used with a plurality of different mobile devices and other battery-powered electronic devices.

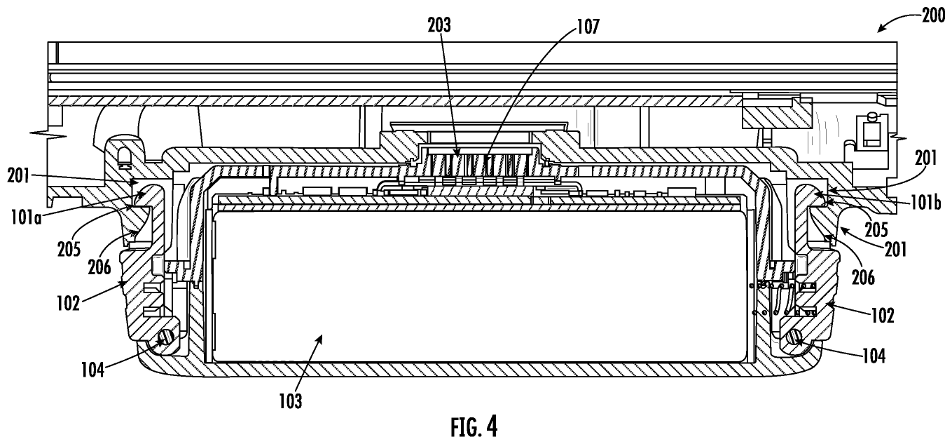

FIGS. 1-12B depict views of example first and second devices (e.g., a battery 100 and battery-powered electronic device 200) and portions thereof in accordance with various embodiments of the present disclosure. FIG. 1 depicts a cross-section of a battery 100, which in the depicted embodiment includes a battery cell 103 and electrical contacts 107 and associated circuitry for powering a battery-powered electronic device and charging the battery. The battery 100 may include an engaging portion 110 configured to be inserted into a corresponding engaging portion of the battery-powered wearable device. The battery 100 in the depicted embodiment includes at least two actuatable hooks 101a, 101b (collectively “101”). In the depicted embodiment, the actuatable hooks 101a, 101b are shown on opposite sides of the battery and opposite sides of the engaging portion 110. With continued reference to FIG. 1, the battery 100 may include at least two actuators 102, which may be formed as part of the respective actuatable hooks and may be configured to actuate the hooks. The battery 100 may further include at least two pins 104 configured to cooperate with the actuatable hooks to define a pivot axis for the hooks in embodiments in which the hooks rotate. In some embodiments, the axes of the pins 104 may be disposed parallel to each other. In some embodiments, the pins (and thus the actuatable hooks) may be disposed opposite each other on a device such that, for example, a single transverse axis may intersect both pins 104 and may be perpendicular to both axes of the pins 104. In various embodiments, at least two actuators 102 may be connected at least in part to a corresponding hook 101. When a user depresses the actuators 102 (e.g., similar to a pinch latch), the corresponding hooks 101 may rotate at least in part around the corresponding pin 104 axis. In one or more embodiments, at least partial rotation of a hook 101 may at least in part cause decoupling of a hook's engaging surface 11 with a corresponding receiving catch (e.g., receiving catch 201 shown in FIG. 4). The battery 100 may further include at least two springs 105 configured to engage a portion of the actuatable hooks and urge the hooks towards their respective engaged positions. Although FIG. 1 depicts the actuatable hooks attached to and operating as part of the battery 100, in some embodiments, the hooks may be attached to the battery-powered electronic device without departing from the scope of the present disclosure.

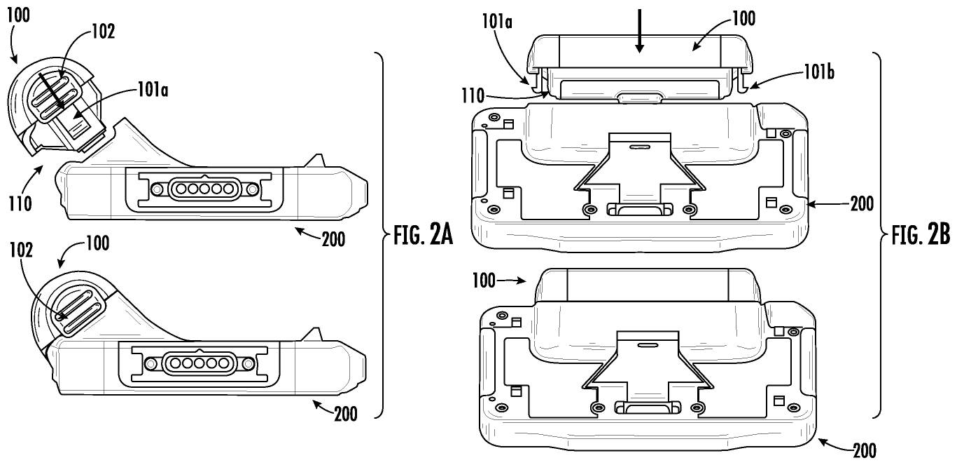

In various embodiments, the first device may be coupled with the second device via a user pushing the two devices together, causing the actuatable hooks to engage the receiving catches between the respective devices. In various embodiments, the first device may be decoupled from the second device via a user depressing the at least two actuators configured to rotate the actuatable hooks out of their respective engaged positions and permit the user to pull the devices apart. With reference to FIG. 2A-2B, the battery 100 and a battery-powered electronic device 200 are depicted in various positions in the process of engaging and/or decoupling. In the example embodiment, depicted by FIGS. 2A-2B, the battery 100 may engage directly with the battery-powered electronic device 200 via the attachment mechanisms described herein. In some embodiments, the battery 100 may include the at least two hooks 101a, 101b, and the hooks may be configured to engage with receiving catches (e.g., receiving catches 201 as seen in FIG. 4) of a second device (e.g., the battery-powered electronic device). In the depicted embodiment, the actuators 102 are part of the actuatable hooks 101 of the battery 100. In some embodiments, the first device may translate into and/or out of engagement with the second device (e.g., the battery moving translationally toward the battery-powered electronic device as shown between FIGS. 2A and 2B). In some embodiments, the user may choose any of a plurality of insertion directions (e.g., rotation and/or translation) and the devices may engage so long as the engaging portions of the two respective devices are connected.

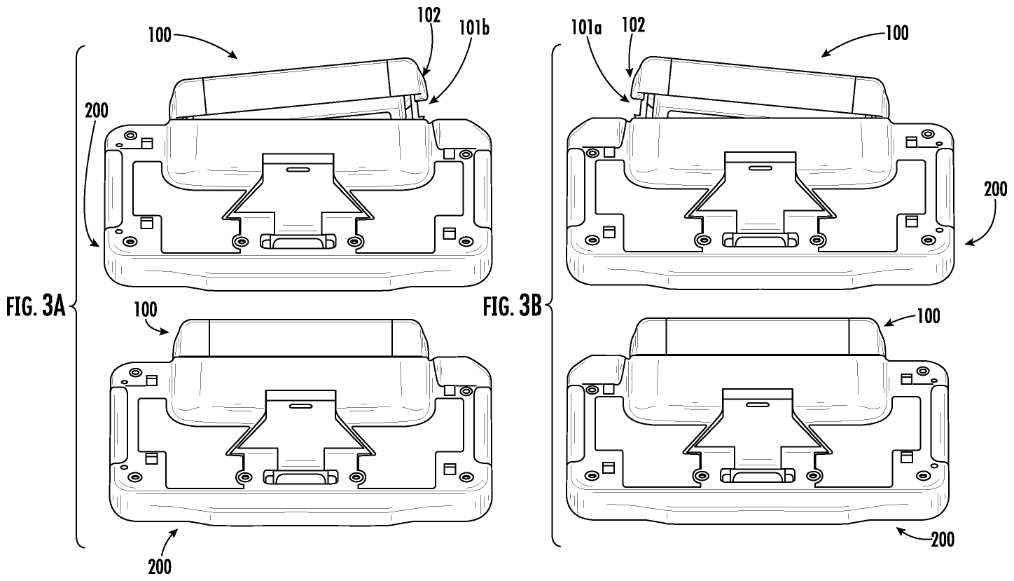

With reference to FIGS. 3A-3B, the battery 100 and the battery-powered electronic device 200 are depicted in various positions in the process of engaging and/or decoupling. In the embodiment depicted in FIGS. 3A-3B, the same structures as FIGS. 2A-2B are shown, and the battery 100 is being engaged with and/or removed from the battery-powered electronic device 200 rotationally. In one or more embodiments, a first device (e.g., the battery 100) may be configured to engage with a second device (e.g., the battery-powered electronic device 200) via one hook 101 being inserted first into and/or removed first from a corresponding receiving catch (e.g., a receiving catch 201 as shown in FIG. 4). Then, the first device and second device may be rotated relative to each other to cause the second hook 101 to subsequently engage and/or disengage from a second corresponding receiving catch. With reference to FIG. 3B, in some embodiments the vice-versa of above may be done to allow users of both left and/or right dominant hands to easily remove a first device 100 from a second device by rotating in either direction. Moreover, the translational decoupling (e.g., the removal process associated with the motion illustrated by FIGS. 2A-2B) may be performed by simultaneously depressing both actuators 102 to release the points of attachment between the battery 100 and the battery-powered electronic device simultaneously, whereas the rotational decoupling (e.g., the removal process associated with the motion illustrated by FIGS. 3A-3B) may be performed by individually depressing a single actuator 102 to release only a single point of attachment to allow the other point of attachment to rotate out asynchronously. In such example embodiments, the user may operate the attachment mechanism in an intuitive way not limited by their mechanical abilities or the attachment configuration of the battery-powered electronic device. In some embodiments, no operation of the actuators 102 is required during engagement of the first device with the second device.

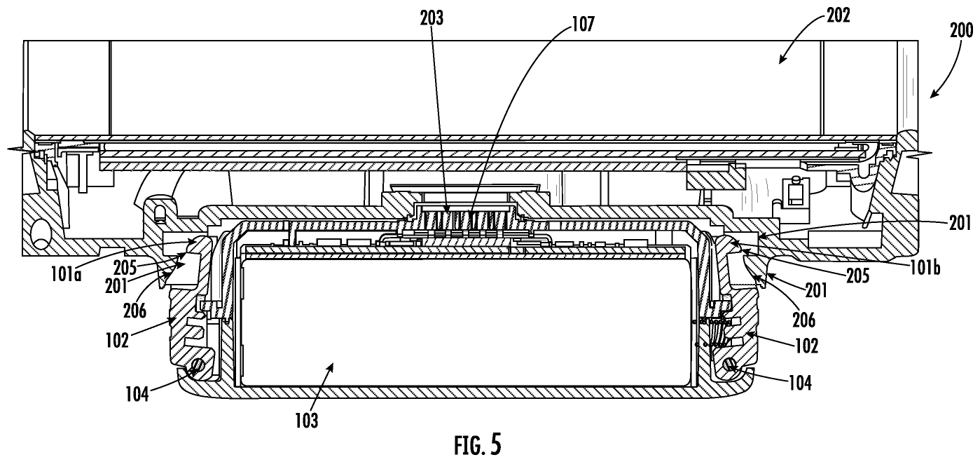

In some embodiments, with reference to FIGS. 4-5, cross-sections are shown of portions of the battery 100 and the battery-powered electronic device 200 showing the engagement and/or disengagement of the actuatable hooks 101 with the receiving catches 201. In various embodiments, the hooks 101 and catches 102 may be disposed on either of the devices. As depicted, at least one hook 101 is configured to rotate with respect to an axis of a pin 104 to engage with and/or disengage from at least one receiving catch 201. Further, in various embodiments, at least one hook 101 may rotate, with respect to a pin 104 axis, in response to a user's operation of one or more actuators 102. In some embodiments, rather than rotating about a pin 104, the hook(s) 101 may translate into and out of engagement with the corresponding receiving catch(es) 102 (e.g., laterally along a channel arranged perpendicular to the direction of insertion).

In various embodiments, the actuatable hooks 101 may include an engaging surface 11 (labeled in FIG. 1) which may be configured to engage with at least one surface 205 of one or more receiving catches 201 to retain the first device and the second device in an engaged configuration. In the depicted embodiment, the engaging surface 11 is flat and disposed parallel to the direction of rotation of the actuatable hooks, such that the engaging surface 11 does not prevent rotation of the hooks but prevents translation and/or rotation of the battery 100 relative to the battery-powered electronic device 102 in an instance in which the devices are engaged and the actuatable hooks are in their engaged positions. In one or more example embodiments, at least one hook 101 may also comprise a curved latching section 12 (labeled in FIG. 1) which may be configured to contact a sloped surface 206 associated with the receiving catches 201 to temporarily deflect the actuator(s) 102 from the engaged position until the engaging surface 11 enters the receiving catch 201 in at least some situations. In some embodiments involving rotational insertion and/or removal of the first device, at least one actuatable hook may remain in the engaged position during insertion and/or removal (e.g., as an end of the first device is translated into engagement with the receiving catch of the second device prior to and/or following rotation). One or more hooks 101 may comprise a straight support arm 13 that connects the engaging surface 11 to the actuator 102 and attachment location of the pin 104. In various embodiments, one or more hooks 101 may be at least in part connected with a spring (e.g., compression spring) 105 to apply a force to urge the one or more hooks towards the engaged position.

In various embodiments, one or more hooks 101 may be rotatable with respect to a pin 104 axis. With reference to FIG. 1, in the depicted embodiments, a first hook 101a may rotate in an inverse direction to a second hook 101b, such that, for example, the rotational direction for moving the first hook 101a towards the engaged position from the disengaged position is opposite the rotational direction for moving the second hook 101b towards the engaged position from the disengaged position (e.g., counter-clockwise versus clockwise). In the depicted embodiments, the hooks 101 are facing opposite directions (e.g., the engaging surfaces 11 are on opposite sides of the support arm 13 from each other, such that the actuatable hooks 101 are configured to engage corresponding receiving catches 201 from opposite directions. In the depicted embodiments, the second hook may be disposed linearly opposite of a first hook. Also in the depicted embodiments, the actuatable hooks 101 themselves have distal ends (e.g., adjacent the curved latching section 12) oriented in the same direction, such that the curved latching section 12 is configured to engage the sloped surfaces of each corresponding receiving catch simultaneously or substantially simultaneously in an instance in which the battery 100 is translated into engagement with the battery-powered electronic device.

One or more actuatable hooks 101 may include a spring 105 which may at least in part restrict free rotation around the pin 104 in direction of compression. In various embodiments, one or more springs 105 may be compressed via engagement with one or more actuators 102 and/or sloped surfaces 206. With the engagement of one or more actuators, one or more hooks 101 may rotate in the direction of spring compress to allow for engaging and/or decoupling. In various embodiments, with the disengagement with one or more actuators, at least one spring at least in part may decompress and may rotate at least one hook 101 to the original location (e.g., the engaged position, which may be the neutral position of the actuatable hooks).

In some embodiments, the actuatable hooks 101 and corresponding receiving catches 201 are the only retention mechanisms used to prevent the two devices from separating. In some instances, one or more other non-retaining alignment features may contact the respective devices and may be used to aid in stability and/or insertion without preventing the devices from being pulled apart under normal operational forces.

In various embodiments, the battery 100 may comprise a battery cell 103 (e.g., lithium, lithium ion, alkaline, carbon zinc, etc.) disposed linearly between the at least two hooks 101. The battery may at least in part be configured to be constrained to a battery slot 108 within the battery 100. In one or more embodiments, a battery cell 103 may be configured to have at least one battery connection points 107 and corresponding circuitry connected thereto, wherein the one or more battery connection points may be configured to transfer power from the battery 100 to a second device (e.g., the battery-powered electronic device 200).

With reference to FIGS. 4-9, the battery-powered electronic device 200 may include an engaging portion in the form of a battery receiving slot 204. The battery receiving slot 204 may comprise the two or more receiving catches 201 configured to engage with the two or more hooks 101 from a first device (e.g., a battery 100). In one or more example embodiments, one or more power connections 107 of the battery 100 may be configured to engage with one or more power contact points 203 (shown in FIG. 4) of the battery-powered electronic device 200. The battery-powered electronic device 200 may include a screen 202 (e.g., a touch screen) and/or one or more wired and/or wireless connections (e.g., via connector 210). In some embodiments, the battery-operated electronic device may have various circuitry configured for the particular use case for which the electronic device is used (e.g., wired and/or wireless communication circuitry, processing circuitry, memory circuitry, input/output circuitry, imaging circuitry, etc.).

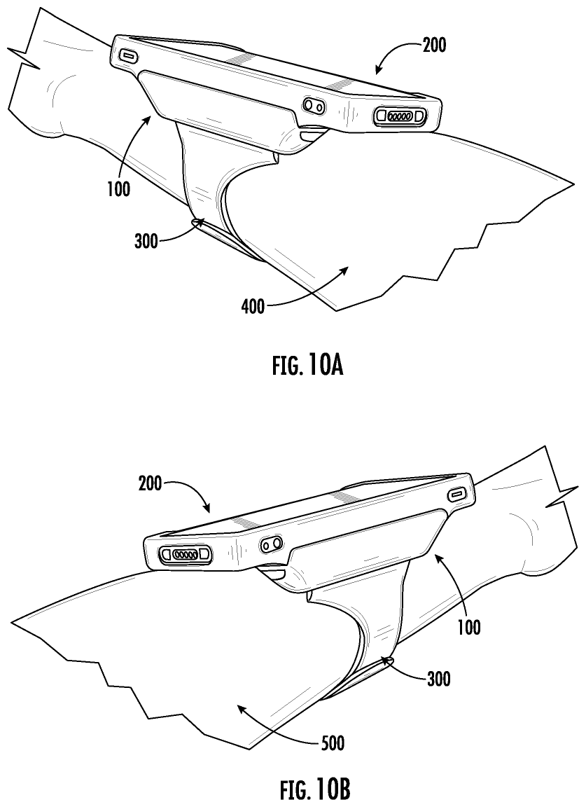

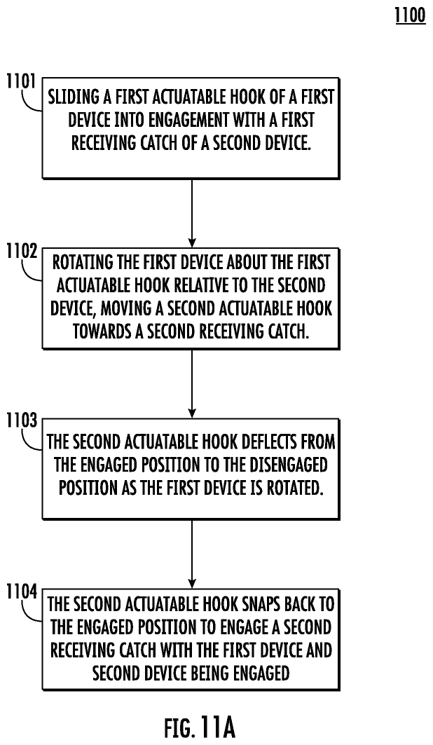

With reference to FIGS. 10A-10B, the battery-powered electronic device 200 may be a portable electronic device, such as a wearable electronic device, an imaging device, a scanner, a mountable electronic device, a phone, a mobile computer, or the like. In some embodiments, the battery-powered electronic device 200 may include a strap 300 to engage with at least one appendage 400/500 or other mounting location, as illustrated in FIGS. 10A-10B. For example, FIG. 10A illustrates the battery-powered electronic device 200 mounted to a user's left arm and FIG. 10B illustrates the battery-powered electronic device 200 mounted to a user's right arm. Wearable configurations of the battery-powered electronic device 200 may benefit from the versatility of the attachment mechanisms disclosed herein.

In various embodiments, an outer housing of the battery 100 and/or the relevant receiving components (e.g., receiving slot 204 and catches 201) of the battery-operated electronic device 200 may be made of a rigid plastic material. In one or more embodiments, the two or more receiving catches 201 and/or the two or more actuatable hooks 101 may be made out of a non-electrically-conductive material and/or a metal coated with a non-electrically-conductive coating at least in part.

In various embodiments, the battery-operated electronic device 200 may comprise the at least two actuatable hooks, wherein the at least two actuatable hooks (e.g., via the same or similar structure and operation to actuatable hooks 101 in FIG. 1) may be configured to engage with a battery 100. In such embodiments, the battery 100 may comprise the at least two receiving catches configured to engage the at least two actuatable hooks. In the depicted embodiment, the battery 100 is offset from a center axis of the battery-powered electronic device (e.g., positioned to the rear of the battery-powered electronic device relative to the viewpoint of the user). In such embodiments, the battery may be positioned to one side of the mounting hardware (e.g., strap 300) such that the battery is not between the mounting hardware and the battery-powered electronic device. This configuration may allow the battery to be removed while still on the user's arm, and the versatility and improved operation afforded by the various embodiments of attachment mechanism disclosed herein may allow the user to engage and disengage a battery without looking at the battery (e.g., from the rear of the device) and in multiple intuitive methods that are robust and able to accommodate misalignment or varying user actions.

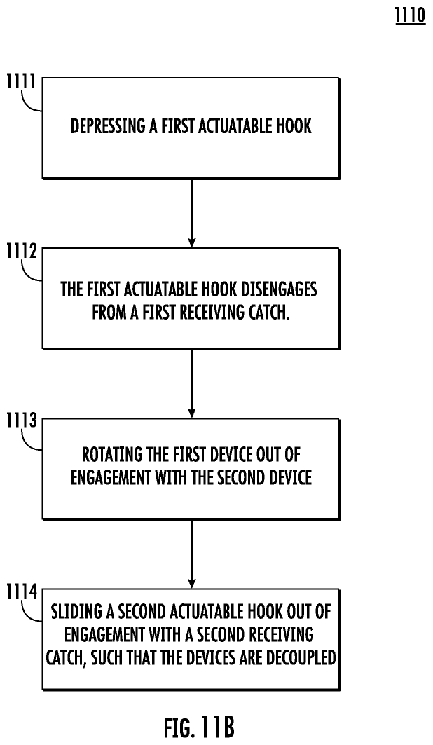

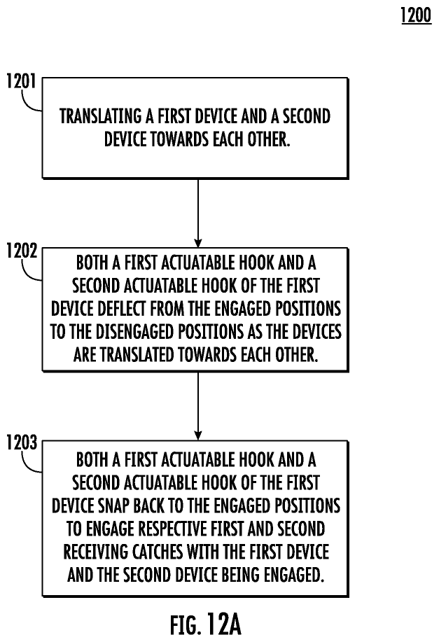

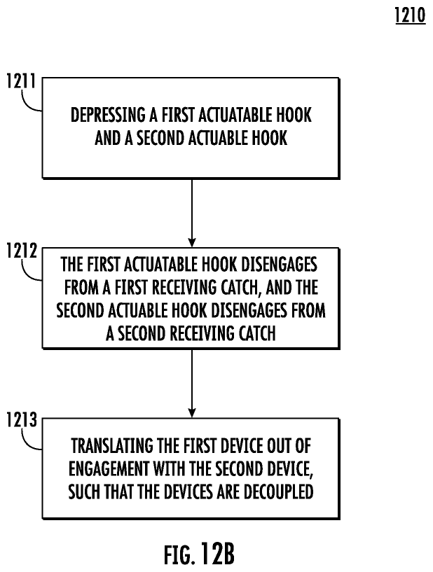

FIGS. 11A-12B depict various methods associated with coupling and/or decoupling a first device with a second device. In one or more embodiments, a first device may be coupled to a second device via two actuatable hooks engaging with two receiving catches. In various embodiments, the counterpart hook(s) and receiving catch(es) may be disposed on either the first device or the second device, wherein a given hook engages a given receiving catch in each instance. In some embodiments, the first device and second device may be engaged such that the hooks and receiving catches engage each other sequentially. In some example embodiments, the first device and second device may be engaged such that the hooks and receiving catches engage each other simultaneously. In one or more embodiments, a first device may be decoupled from a second device, wherein a first actuatable hook disengages from a first receiving catch and a second actuatable hook disengages from a second receiving catch sequentially. In another example embodiments, a first device may be decoupled from a second device, wherein a first actuatable hook disengages from a first receiving catch and a second actuatable hook disengages from a second receiving catch simultaneously.

FIGS. 11A-12B are example flow diagrams illustrating methods for coupling and/or decoupling a first device from a second device in accordance with various embodiments of the present disclosure. In various embodiments, these example flow diagrams illustrated in FIGS. 11A-12B for decoupling 1100 and/or 1200 are performed in reference to various devices in accordance with various embodiments of the present disclosure. For example, the steps in the example flow diagrams in FIGS. 11A-12B (e.g., 1101, 1102, 1103, 1104, 1105, 1201, 1202, 1203) may be performed sequentially, while in other embodiments the steps may occur simultaneously (e.g., 1102, 1103 and 1202, 1203).

In at least one embodiment, the flow diagram of FIGS. 11A-11B may be performed similar to the operations shown in FIGS. 3A, 3B, and 5, and reference numerals not shown in FIGS. 11A-11B will be in reference to the remaining figures of the disclosure, including at least FIG. 3A, 3B, or 5 in the disclosure. However, it may be understood that the flow diagram of FIGS. 11A-11B can be performed with any suitable mechanism(s).

In at least one embodiment, the flow diagram of FIGS. 12A-12B may be performed similar to the operations shown in FIGS. 2A, 2B, and 5, and reference numerals not shown in FIGS. 12A-12B will be in reference to the remaining figures of the disclosure, including at least FIG. 2A, 2B, 5, or 6-8 in the disclosure. However, it may be understood that the flow diagram of FIGS. 12A-12B can be performed with any suitable mechanism(s).

FIGS. 11A-11B describe various operations with respect to a first device and second device either coupling (e.g., moving into an engaged position) or decoupling (e.g., separating from the engaged position). While described with respect to particular features being associated with the respective devices, it would be understood that the features may be interchanged (e.g., a “second device” may include the “hook”, etc.) without departing from the scope of the present disclosure.

As shown in at least FIG. 11A, in accordance with various aspects of the present disclosure, an example rotational method for coupling two devices 1100 is provided in which at least one actuatable hook deflects inwardly during coupling. In various embodiments, depicted at step 1101, a first actuatable hook of a first device may slide into engagement with a first receiving catch of a second device. In various embodiments, depicted at step 1102, a first device may be rotated about the first actuatable hook, wherein the rotation is relative to the second device and a second actuatable hook is moved towards a second receiving catch. In various embodiments, depicted at step 1103, a second actuatable hook may deflect from the engaged position towards the disengaged position while a user rotates a first device towards the second device. In various embodiments, depicted at step 1104, a second actuatable hook may deflect from a disengaged position to an engaged position, wherein a second actuatable hook engages with a second receiving catch of a second device. Following the depicted process 1100, the first device and the second device are engaged.

As shown in FIG. 11B, in various embodiments, an example decoupling method 1110 may rotationally decouple the devices. In various embodiments, depicted at step 1111, a first actuatable hook may be depressed, which may cause, at step 1112, the first actuatable hook to disengage from the first receiving catch. In various embodiments, depicted at step 1113, with the first actuatable hook depressed, a user may rotate the first device out of engagement with the second device, which may partially or completely disengage the second actuatable hook from the second receiving catch (e.g., rotation of the devices may allow the second hook/catch to decouple without requiring depression of the second actuatable hook). In various embodiments, depicted at step 1114, the second actuatable hook may slide out of engagement with a second receiving catch, wherein the result is a first device is decoupled from a second device. For example, once the first actuatable hook is rotated clear of the second device, the user may translate the first device relative to the second device to slide the remainder of the first device away from the second device.

As shown in FIG. 12A, in accordance with various aspects of the present disclosure, an example translational method for coupling two devices 1200 is provided. In various embodiments, depicted at step 1201, a first device may be translated towards a second device. In various embodiments, depicted at step 1202, both a first actuatable hook and a second actuatable hook may deflect from their respective engaged position to their respective disengaged position while the first device and the second device are translating towards each other (e.g., when the actuatable hooks contact the entrance to the engaging portion of the second device and deflect inwardly). In various embodiments, depicted at step 1203, both a first actuatable hook and a second actuatable hook may snap back to their engaged positions (e.g., once the devices translate close enough that the hook portions of the actuatable hooks enter the receiving catches), such that a first actuatable hook engages with a first receiving catch of the second device and a second actuatable hook engages with a second receiving catch of the second device. In various embodiments, the completion of step 1203 results in a first device being engaged with a second device.

As shown in FIG. 12B, in various embodiments, an example translational decoupling method 1210 is provided. In various embodiments, depicted at step 1211, a user may depress both the first actuatable hook and the second actuatable hook (e.g., rotating the hooks about their pivot pin axes). At the depicted step 1212, the first actuatable hook disengages from the first receiving catch of the second device, and the second actuatable hook disengages from the second receiving catch of the second device. In various embodiments, depicted at step 1213, the first device is translated away from the second device resulting in the decoupling of the first device from the second device.

Many modifications and other embodiments of the present disclosure set forth herein will come to mind to one skilled in the art to which this disclosure pertains having the benefit of the teachings presented in the foregoing description and the associated drawings. Therefore, it is to be understood that the present disclosure is not to be limited to specific embodiments disclosed and that modifications and other embodiments are intended to be included within the scope of the appended claims. Moreover, although the foregoing description and the associated drawings describe example embodiments in the context of certain example combination of elements and/or functions, it should be appreciated, in light of the present disclosure, that different combinations of elements and/or functions than those explicitly described above are also contemplated as can be set forth in some of the appended claims. Although specific terms are employed herein, they are used in a generic and descriptive sense only and not for purpose of limitation.

What is claimed is:

1. A device comprising:
two actuatable hooks comprising a first actuatable hook and a second actuatable hook, the first actuatable hook configured to move between a first engaged position and first disengaged position, the second actuatable hook configured to move between a second engaged position and second disengaged position,
wherein the first actuatable hook is actuatable in a different direction than the second actuatable hook; and
wherein the two actuatable hooks are each configured to engage with one or more corresponding receiving catches on a receiving device in the first engaged position and the second engaged position, respectively.

2. The device of claim 1, wherein the two actuatable hooks are rotatable about respective pin axes.

3. The device of claim 2, wherein the respective pin axes are parallel to each other.

4. The device of claim 1, wherein each of the two actuatable hooks comprise an actuator configured to be depressed by a user, wherein the actuatable hooks are each configured to rotate about a respective pin axis in response to actuation of the respective actuators.

5. The device of claim 1, wherein the device is a battery, and the receiving device is a battery-powered electronic device.

6. The device of claim 1, wherein at least one of the two actuatable hooks comprises a spring configured to urge the at least one of the two actuatable hooks towards the respective engaged positions.

7. The device of claim 1, wherein the two actuatable hooks are oriented such that the two actuatable hooks are configured to move in inverse directions between the respective engaged positions and the respective disengaged positions.

8. The device of claim 1, wherein the two actuatable hooks are disposed on opposite sides of an engagement portion of the device.

9. An assembly comprising:
a first device comprising two actuatable hooks including a first actuatable hook and a second actuatable hook, the first actuatable hook configured to move between a first engaged position and first disengaged position, the second actuatable hook configured to move between a second engaged position and second disengaged position, wherein the first actuatable hook is actuatable in a different direction than the second actuatable hook; and
a second device comprising two receiving catches including a first receiving catch configured to engage the first actuatable hook and a second receiving catch configured to engage the second actuatable hook.

10. The assembly of claim 9, wherein the first device is configured to engage the second device by engaging the first actuatable hook with the first receiving catch and engaging the second actuatable hook with the second receiving catch.

11. The assembly of claim 10, wherein the first device is configured to translate into engagement with the second device, wherein during the translation both the first actuatable hook and the second actuatable hook are configured to deflect from the respective engaged positions temporarily towards the respective disengaged positions before the first actuatable hook engages the first receiving catch and the second actuatable hook engages the second receiving catch.

12. The assembly of claim 11, wherein the first device is configured to rotate into a first engagement with the second device without rotating the second actuatable hook from the second engaged position, wherein during the rotation of the first engagement, the first actuatable hook is configured to deflect from the first engaged position temporarily towards the first disengaged position before the first actuatable hook engages the first receiving catch.

13. The assembly of claim 12, wherein the first device is configured to rotate into a second engagement with the second device without rotating the first actuatable hook from the first engaged position, wherein during the rotation of the second engagement, the second actuatable hook is configured to deflect from the second engaged position temporarily towards the second disengaged position before the second actuatable hook engages the second receiving catch.

14. The assembly of claim 9, wherein the first device is a battery, and the second device is a battery-powered electronic device configured to engage the battery to receive power.

15. The assembly of claim 14, wherein battery-powered electronic device is configured to attach to a user's appendage, and wherein the battery is configured to engage and disengage from the battery-powered electronic device while the battery-powered electronic device is attached to the user's appendage.

16. The assembly of claim 9, wherein each of the two actuatable hooks comprise an actuator configured to be depressed by a user, wherein the actuatable hooks are each configured to rotate about a respective pin axis in response to actuation of the respective actuators.

17. The assembly of claim 16, wherein the respective pin axes are parallel to each other, and wherein the two actuatable hooks are configured to rotate in inverse directions between the respective engaged positions and the respective disengaged positions.

18. The assembly of claim 9, further comprising springs associated with the two actuatable hooks, and wherein the springs are configured to urge the two actuatable hooks towards the respective engaged positions.

19. The assembly of claim 9, wherein the two actuatable hooks are disposed on opposite sides of an engagement portion of the first device, and wherein the two receiving catches are disposed on opposite sides of an engagement portion of the second device.

20. A method of decoupling two devices, the two devices comprising a first device comprising two actuatable hooks including a first actuatable hook and a second actuatable hook, the first actuatable hook configured to move between a first engaged position and first disengaged position, the second actuatable hook configured to move between a second engaged position and second disengaged position, wherein the first actuatable hook is actuatable in a different direction than the second actuatable hook; and a second device comprising two receiving catches including a first receiving catch configured to engage the first actuatable hook and a second receiving catch configured to engage the second actuatable hook; the method comprising:
depressing at least one of the two actuatable hooks, and
decoupling the two devices.
